(19) United States
(12) Patent Application Publication
(10) Pub. No.: US 2026/0302818 A1
(43) Pub. Date: Oct. 1, 2026

(54) DEVICE CHARGING ALGORITHM SELECTION FROM USER CRITERIA

(71) Applicant: Zebra Technologies Corporation, Lincolnshire, IL (US)

(72) Inventors: Ying Jia, Guangzhou (CN); Hongqiang Liu, Guangzhou (CN); Jian Jiang, Guangzhou (CN)

(21) Appl. No.: 19/153,487

(22) PCT Filed: Dec. 18, 2023
(86) PCT No.: PCT/CN2023/139664

§ 371 Date: Aug. 4, 2025

(51) Int. Cl. H02J 7/92; H02J 7/40; H02J 7/50

(52) U.S. Cl. CPC H02J 7/92; H02J 7/40; H02J 7/50

(57) ABSTRACT

Systems, methods, and apparatuses for selecting device charging algorithms based at least partially upon criteria received from a user are provided herein. An example method includes configuring a device to charge a battery using the two or more charging algorithms, receiving criteria for the two or more charging algorithms from a user, selecting a first charging algorithm from the two or more charging algorithms based at least partially on satisfaction of the criteria received from the user, and charging the battery using the first charging algorithm.

### BACKGROUND

Many portable devices include one or more batteries which are periodically charged to maintain device operability. Charging a battery typically involves applying an electric potential, greater than that which the battery currently produces, across electrical terminals of the battery. A charging algorithm determines how much electrical potential (if any at all) should be applied at a given time in a charging cycle. The charging algorithm may take in measured data, such as a state of charge of a battery, or may operate solely upon information available internally to the algorithm, such as an elapsed charging time.

### SUMMARY

Systems, methods, and apparatuses are provided herein for selecting device charging algorithms based at least partially upon criteria received from a user. In an example embodiment, a method comprises configuring a device to charge a battery using the two or more charging algorithms, receiving criteria for the two or more charging algorithms from a user, selecting a first charging algorithm from the two or more charging algorithms based at least partially on satisfaction of the criteria received from the user, and charging the battery using the first charging algorithm. In a variation of this example embodiment, the method further comprises selecting a second charging algorithm from the two or more charging algorithms and switching from the first charging algorithm to the second charging algorithm based on the criteria, e.g., which can include, for example, a time specified by the user. In a variation of this example embodiment, the time is an elapsed value measured from a start of the charging. In a variation of this example embodiment, the time is a time of day. In a variation of this example embodiment, the method further comprises measuring the time via a clock that is internal to the device. In a variation of this example embodiment, the method further comprises receiving, by the device, a signal which indicates the time from an external clock. In a variation of this example embodiment, the configuring is achieved via communication between the device and a server. In a variation of this example embodiment, the configuring is achieved via direct communication or local area network (LAN) communication between a host and the device. In a variation of this example embodiment, the battery is included in a second device. In a variation of this example embodiment, the device is a printer or an indicia decoder. In a variation of this example embodiment, the configuring is performed for a plurality of devices simultaneously.

In another example embodiment, a system comprises a battery, a power supply, a device, and a processing device, configured to configure a device to charge a battery via the power supply using the two or more charging algorithms, receive criteria for the two or more charging algorithms from a user, select a first charging algorithm from the two or more charging algorithms based at least partially on satisfaction of the criteria received from the user, and cause the device to charge, via the power supply, the battery using the first charging algorithm. In a variation of this example embodiment, the device is a charging device, and the battery is included in a second device which interfaces with the charging device. In a variation of this example embodiment, the processing device is further configured to select a second charging algorithm from the two or more charging algorithms and switch from the first charging algorithm to the second charging algorithm based on the criteria, e.g., which can include, for example, a time specified by the user. In a variation of this example embodiment, the time is an elapsed value measured from a start of the charging. In a variation of this example embodiment, the time is a time of day. In a variation of this example embodiment, the processing device is included in a server which interfaces with the device. In a variation of this example embodiment, the processing device is included in a host which communicates via a direct connection or a local area network (LAN) with the device.

In yet another example embodiment, a non-transitory computer-readable medium contains instructions which, when executed by a processing device, cause the processing device to configure a device to charge a battery via the power supply using the two or more charging algorithms, receive criteria for the two or more charging algorithms from a user, select a first charging algorithm from the two or more charging algorithms based at least partially on satisfaction of the criteria received from the user, and cause the device to charge, via the power supply, the battery using the first charging algorithm. In a variation of this example embodiment, the non-transitory computer-readable medium contains further instructions which cause the processing device to select a second charging algorithm from the two or more charging algorithms and switch from the first charging algorithm to the second charging algorithm based on a time specified by the user.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed subject matter, and explain various principles and advantages of those embodiments.

FIG. 1 illustrates an example system for charging an internal battery using a charging algorithm selected based at least in part upon criteria from a user, according to embodiments of the present disclosure.

FIG. 2 illustrates an example system for charging a battery in an external device using a charging algorithm selected based at least in part upon criteria from a user, according to embodiments of the present disclosure.

FIG. 3 illustrates a method for charging a battery using a charging algorithm selected based at least in part upon criteria from a user, according to embodiments of the present disclosure.

FIG. 4 illustrates a method for switching between charging algorithms when charging a battery, according to embodiments of the present disclosure.

FIG. 5 illustrates an example system for charging multiple batteries in multiple devices, according to embodiments of the present disclosure.

FIG. 6 illustrates an example system which includes a printing device with a cradle, according to embodiments of the present disclosure.

FIG. 7 illustrates a user interfacing with an example system which includes a printing device with a cradle, according to embodiments of the present disclosure.

FIG. 8 illustrates an example portable printer, according to embodiments of the present disclosure.

FIGS. 9A-9D illustrate example charging algorithms, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Systems, methods, and apparatuses are provided herein for selecting device charging algorithms based at least partially upon criteria received from a user. Existing battery charging systems are typically very user-opaque and relatively unsophisticated, with a single charging algorithm being used to charge a battery without user input or control (beyond connecting the battery to the charging systems, of course). While these systems are very simple to manufacture and use, there are a plethora of situations in which better control of battery charging is desirable. For example, electricity pricing is often dependent upon demand, with off-peak times offering much cheaper electricity than high-demand times. Existing systems are usually unable to take factors such as this into consideration when charging a battery, and will thus charge a connected battery with the same algorithm at peak demand times as at off-peak times. This is one of many examples of the shortcomings of systems with low or no user configurability.

Systems, methods, and apparatuses of the present disclosure advantageously solve these issues by configuring a device with multiple charging algorithms and allowing a user to set criteria which can then be used by the device to select one of charging algorithms. For example, a user may input ranges of times when electricity prices are expected to be lower than average, and embodiments of the present disclosure may select one or more charging algorithms to ensure that most or all battery charging occurs during the low-priced periods.

This concept can be expanded to include multiple criteria simultaneously. For example, a user may provide a preferred target charged time, time periods when electricity costs are anticipated to be low, and a maximum electrical current to be drawn. Systems, methods, and apparatuses of the present disclosure may balance these criteria to select a charging algorithm that best fits the criteria received from the user. These criteria may have weights applied corresponding to priority, thus allowing a user to indicate a preference or priority for one criterion to be satisfied without significantly degrading performance with regard to more important criteria.

This concept can also be expanded to accommodate charging multiple batteries simultaneously, with the possibility of implementing systems, methods, or apparatuses which take into account user criteria, data about a charging state of a battery, data about charging states of other batteries, energy pricing data, and more to coordinate large-scale battery charging in a way that minimizes electricity costs, avoids overloading circuits, and offers potentially superior charging performance overall compared to existing systems.

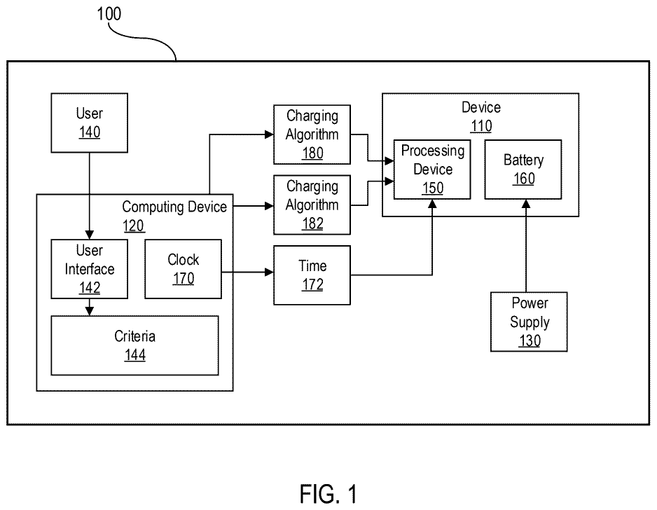

FIG. 1 illustrates an example system 100 in which a device 110 is configured to implement charging algorithms for charging a battery 160 of the device 110 using the charging algorithms selected by the device 110 or a different device in communication with the device 110 (e.g., a computing device 120) based at least in part upon criteria 144 from a user 140, according to embodiments of the present disclosure. The device 110 interfaces with a power supply 130 to charge the battery 160. The device 110 may include a processing device 150 configured to receive a first charging algorithm 180, a second charging algorithm 182, and a time 172 from the computing device 120, which may be embodied as, e.g., a host or server. The computing device 120 may select the first charging algorithm 180 and the second charging algorithm 182 based upon criteria 144 that the computing device 120 receives from the user 140 via a user interface 142. In this example embodiment, the computing device 120 includes a clock 170 which measures the time 172. The device 110 can be a mobile phone, a tablet, a laptop, a barcode reader, a media processing device, such as a printer (e.g., a portable thermal printer), a radiofrequency identification device (RFID) encoder or reader, a camera, and/or other electronic devices that are powered by a battery.

This example embodiment is one where the computing device 120 receives the criteria, selects a charging algorithm to implement for a set of possible charging algorithms, and instructs the device 110 to implement the selected charging algorithm. It will be appreciated that in varying embodiments, the device 110 may be configured to receive and store the criteria, select a charging algorithm from a set of possible charging algorithms, and execute the selected charging algorithm in response to the selection. In some embodiments, the device 110 can include the criteria 144, the charging algorithms 180 and 182, the user interface 142, the clock 170, and/or the power supply 130. In such a scenario, the device 110 may internally perform the tasks or at least some of the tasks illustrated and described herein as being performed by the computing device 120. For example, in some embodiments, the system 100 may exclude the computing device 120 such that the device 110 performs the operations and functions described herein for specifying the criteria, selecting the charging algorithm, and implementing the charging algorithm without input from the computing device 120. It will also be appreciated that the computing device 120 may or may not be remote relative to the device 110, and that communication between the computing device 120 and the device 110 may be over the internet, a local area network (LAN), a company network, a direct wired connection, combinations thereof, or any other means of communication.

The computing device 120 may select and send the first charging algorithm 180 responsive to a determination that the first charging algorithm 180 satisfies the criteria or constitutes a best fit for satisfying the criteria 144 at a given time. The best fit may be determined, for example, based on a priority, ranking, or weighting of the criterion forming the criteria and/or a degree to which the criterion is or is not satisfied. The computing device 120 may send the second charging algorithm 182 upon determining that the second charging algorithm 182 subsequently satisfies the criteria 144 or has become the best fit for satisfying the criteria 144, or the computing device 120 may anticipatorily send the second charging algorithm 182 along with instructions regarding when the device 110 should switch from the first charging algorithm 180 to the second charging algorithm 182. Those skilled in the art will appreciate that the latter strategy may only be practical when a switch between the first charging algorithm 180 and the second charging algorithm 182 is easily predicted, such as when such a switch depends entirely on the time 172. As described herein, the device 110 may alternatively store the charging algorithms, select the algorithms based on the criteria, implement the selected charging algorithms, and/or switch from one charging algorithm (e.g., charging algorithm 180) to another algorithm (e.g., charging algorithm 182).

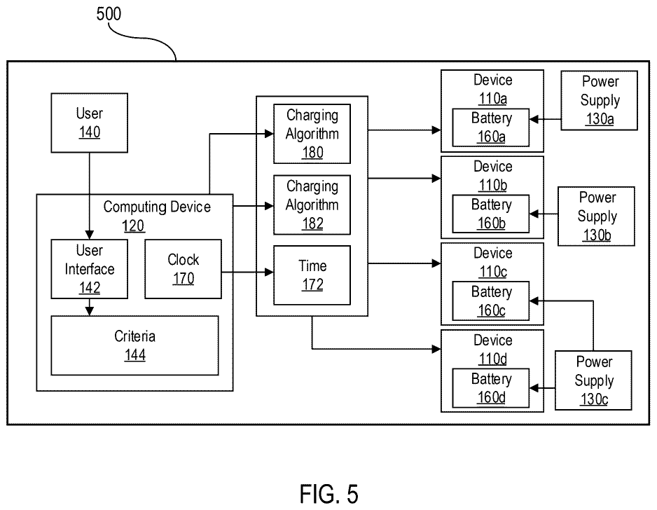

The criteria may include but are not limited to times at which charging with greater power throughput is desirable, electricity prices above or below which a charging rate should be reduced or increased, a desired charging completion time, limitations of a circuit which contains the power supply 130, or any other user-configurable information which may be pertinent to changing the rate at which the battery 160 should be charged. In making decisions about which charging algorithm to employ, the device 110 may receive data such as but not limited to a current charge state of the battery 160, a current price of electricity, a time 172, an elapsed time of charge, activities of other devices which are charging (see FIG. 5), or any other data pertinent to changing the rate at which the battery 160 should be charged. This data may be used in tandem with the criteria 144, and may be employed in choosing a charging algorithm even when the criteria 144 do not specify a desired range of values or a desired behavior for that data explicitly. For example, the processing device 150 may be configured to automatically account for other devices which are charging simultaneously to avoid overcurrent scenarios without the need for user configuration.

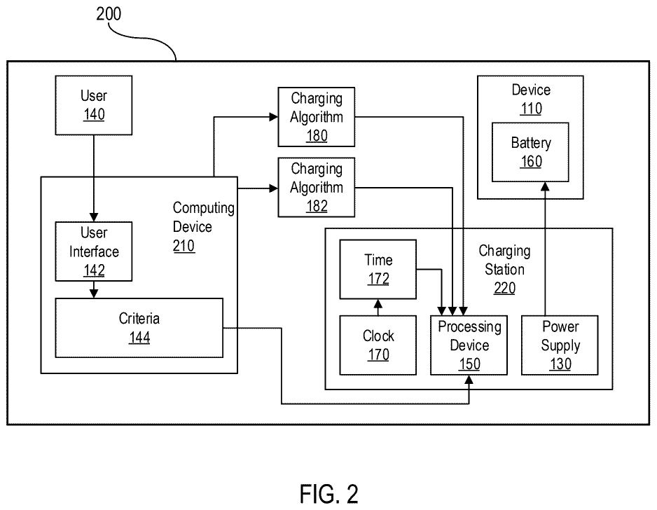

FIG. 2 illustrates an example system 200 in which a charging station 220 is configured to implement charging algorithms for charging a battery 160 of the device 110 using the charging algorithms selected by the charging station 220 or a different device (e.g., a computing device 210) in communication with the charging station 220 based at least in part upon criteria 144 from a user 140, according to embodiments of the present disclosure. In this example embodiment, the device 110 interfaces with the charging station 220 to cause a power supply 130 of the charging station 220 to charge the battery 160 of the device 110. The computing device 210, such as, e.g., a host or server, receiving input from a user 140 via a user interface 142 may collect and forward criteria 144 to a processing device 150 of the charging station 220. The computing device 210 may also send a first charging algorithm 180 and a second charging algorithm 182 to the processing device 150. The charging station 220 uses the first charging algorithm 180 and/or the second charging algorithm 182, along with a time 172 input from an internal clock 170, to charge the battery 160 when the device 110 is connected to the charging station 220. While the device 110 has been illustrated as interfacing with the charging station 220 to charge the batter 160, in some embodiments, the battery 160 can be removed from the device 110 and operatively coupled to the charging station 220 to charge the battery 160 while it is decoupled from the device 110.

As with FIG. 1, the computing device 210 may send the first charging algorithm 180 to the charging station 220 responsive to a determination that the first charging algorithm 180 satisfies the criteria 114 or is a best for satisfying the criteria 144, then send the second charging algorithm 182 to the charging station 220 responsive to a determination that the second charging algorithm 182 is determined to subsequently satisfy the criteria 144 or correspond to the best fit for satisfying the criteria 144. Also as in FIG. 1, the computing device 210 may anticipatorily send the second charging algorithm 182 along with instructions regarding when the device 110 should switch from the first charging algorithm 180 to the second charging algorithm 182. The charging station 220 may alternatively store the charging algorithms, select the algorithms based on the criteria, implement the selected charging algorithms, and/or switch from one charging algorithm (e.g., charging algorithm 180) to another algorithm (e.g., charging algorithm 182) without receiving instructions from the computing device 210.

It will be appreciated that the computing device 210 or the device 110 may perform some functions illustrated as being performed by the charging station 220 herein. For example, the charging station 220 may lack the clock 170, instead relying on a clock 170 located within the device 110 or the computing device 210 for time 172 measurements. It will also be appreciated that many charging algorithms (including the first charging algorithm 180 and the second charging algorithm 182) may be pre-loaded onto the charging station 220. In such an embodiment, the computing device 210 may not send the first charging algorithm 180 or the second charging algorithm 182 each time a charging cycle begins, instead simply forwarding the criteria 144 to the charging station 220. The charging station 220 may then select the first charging algorithm 180, the second charging algorithm 182, or another preloaded algorithm based at least partially upon satisfaction of the criteria 144. It will be further appreciated that the computing device 210 may facilitate loading additional charging algorithms onto the charging station 220. It will also be appreciated that the computing device 210 may or may not be remote relative to the device 110, and that communication between the computing device 210 and the device 110 may be over the internet, a local area network (LAN), a company network, a direct wired connection, combinations thereof, or any other means of communication.

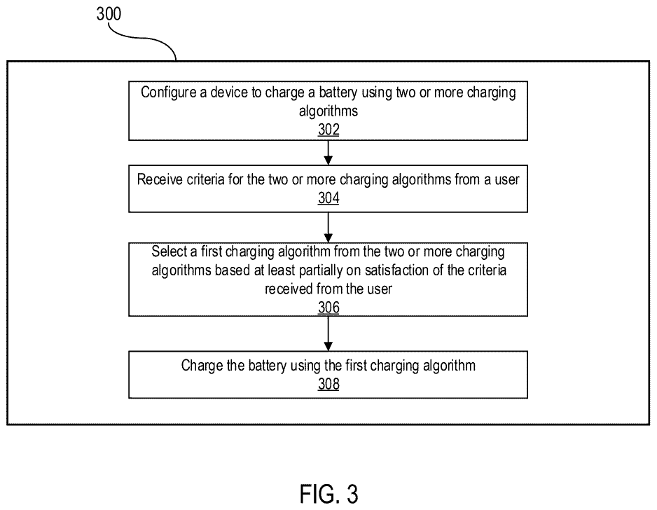

FIG. 3 illustrates a method 300 for charging a battery using a charging algorithm selected based at least in part upon criteria from a user, according to embodiments of the present disclosure. It will be appreciated that the method 300 is presented with a high degree of abstraction, and that particular implementations of the method 300 may differ from that which is presented herein. In particular, additional steps not described herein may be included.

At block 302, an example computing device (e.g., computing device 120 or 210) configures a target device (e.g., the device 110 or charging station 220) to charge a battery using two or more charging algorithms. For example, the computing device may pre-load the target device with a first charging algorithm 180 for minimizing power draw and a second charging algorithm 182 for minimizing charging time when charging a battery 160. The computing device may pre-load additional charging algorithms as well. The method 300 then proceeds to block 304.

At block 304, an example processing device (e.g., the processing device 150) of the target device receives criteria for the two or more charging algorithms from a user (e.g., the user 140). For example, criteria received from the user via a user interface (e.g., the user interface 142) may indicate to the processing device of the target device that the target device should try to draw the most current between the hours of 1 am and 4 am to keep electricity costs low, and that the charging needs to be completed by the 8 am start of the next day's shift.

At block 306, the example processing device selects a first charging algorithm from the two or more charging algorithms based at least partially on satisfaction of the criteria received from the user. For example, the processing device, upon determining that the current time is 12 am, may initially select the first charging algorithm 180 to minimize power consumption until the 1 am-4 am window occurs.

At block 308, an example power supply charges the battery using the first charging algorithm. For example, the processing device may communicate with the power supply 130 to begin applying a specified voltage across terminals of the battery 160 according to the first charging algorithm 180.

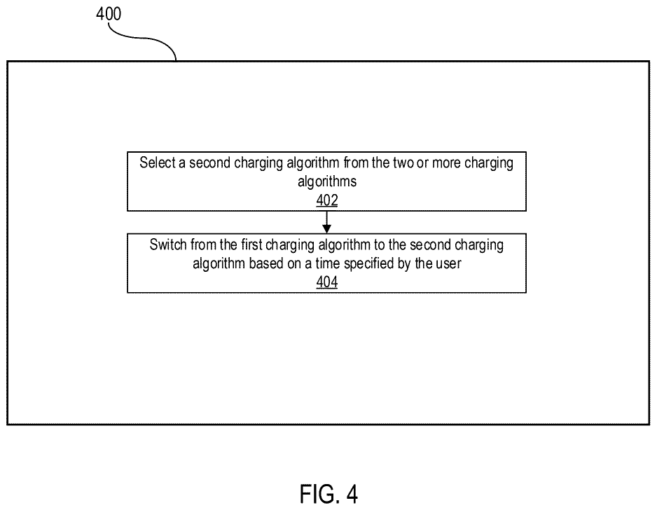

FIG. 4 illustrates a method 400 for switching between charging algorithms when charging a battery, according to embodiments of the present disclosure. It will be appreciated that the method 400 is presented with a high degree of abstraction, and that particular implementations of the method 400 may differ from that which is presented herein. In particular, additional steps not described herein may be included.

At block 402, an example processing device (e.g., the processing device 150) of a target device (e.g., device 110 or charging station 220) selects a second charging algorithm from the two or more charging algorithms. For example, continuing the example of FIG. 3, a clock (e.g., the clock 170) may indicate that the time is now 1 am, causing the processing device to determine that the second charging algorithm 182 should now be used to achieve full charge by the 8 am deadline while drawing the most possible power during the 1 am-4 am window specified by criteria received from the user.

At block 404, the example processing device switches from the first charging algorithm to the second charging algorithm based on a time specified in the criteria by the user. For example, now that the 1 am-4 am time window specified in the criteria by the user is occurring, the processing device may instruct a power supply (e.g., the power supply 130) to increase a voltage across terminals of the battery 160 or a current to match that which is indicated by the second charging algorithm 182.

FIG. 5 illustrates an example system 500 for charging multiple batteries 160a-d in multiple devices 110a-d, according to embodiments of the present disclosure. As with FIG. 1, the computing device 120 receives the criteria 144 from the user 140 via the user interface 142. The computing device 120 may then select a first charging algorithm 180 and a second charging algorithm 182 based at least partially on the criteria 144. The computing device 120 may send the first charging algorithm 180, the second charging algorithm 182, and an indication of the current time 172 measured by a clock 170 internal to the computing device 120 to the multiple devices 110a-d. Each of the multiple devices, in turn, interfaces with one of multiple power supplies 130a-c to charge respective batteries 160a-d. The respective power supplies 130a-c may be instructed by the respective multiple devices 110a-d to supply a voltage across terminals of respective batteries 160a-d indicated by current charging algorithm (e.g. the first charging algorithm 180 or the second charging algorithm 182).

It will be appreciated that different devices of the multiple devices 110a-d may be configured to simultaneously employ different charging algorithms when charging respective batteries of the multiple batteries 160a-d. This may be coordinated by the computing device 120 or may be chosen based on the criteria 144 by the respective devices of the multiple devices 110a-d. It will also be appreciated that the criteria 144 may take into account behaviors of the other respective devices of the multiple devices 110a-d. For example, in order to avoid drawing too much current for a particular circuit, a charging algorithm may need to be chosen which limits current draw for each individual device of the multiple devices 110a-d. Individual devices of the multiple devices 110a-d may be prioritized in current limiting. For example, if a first device 110a needs to be charged (per the criteria 144) by 8 am while a second device 110b needs to be charged by 9 am, the first device 110a may be allocated a larger current limit than the second device 110b. Once the first device 110a reaches an acceptable charge state, the first device 110a may be deprioritized in favor of other devices (e.g. the second device 110b) which still need to charge.

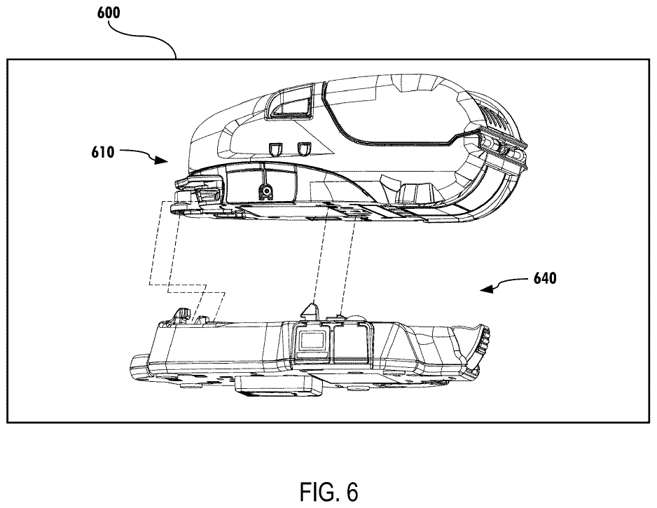

FIG. 6 illustrates an example media processing device in the formal of a printing system 600 with a cradle 640, according to embodiments of the present disclosure. The cradle 640 can be a charging station for charging a battery of a printing device 610 as described herein. The user can attach printing device 610, for example, to cradle 640. It should be appreciated that the cradle (e.g., cradle 640) is configured to receive printing device 610 simply and efficiently with a user driving the printing device 600 into a docked position with the cradle 640.

When the printing device 610 is engaged/docked with the cradle 640, electrical contact may be made between contacts on the cradle 640 and contacts on the printing device 610, allowing the cradle 640 to charge a battery within the printing device 610. This may take the form of the system illustrated in FIG. 2, wherein the cradle 640 is implemented as the charging station 220 and controls charging of the battery 160. Alternatively, the printing device 610 may control charging of the battery 160 as in FIG. 1, with the cradle 640 acting (at least for the purposes of battery charging) merely as a power supply with convenient docking. Further still, the printing device 610 and the cradle 640 may operate in combination to control charging of the battery 160.

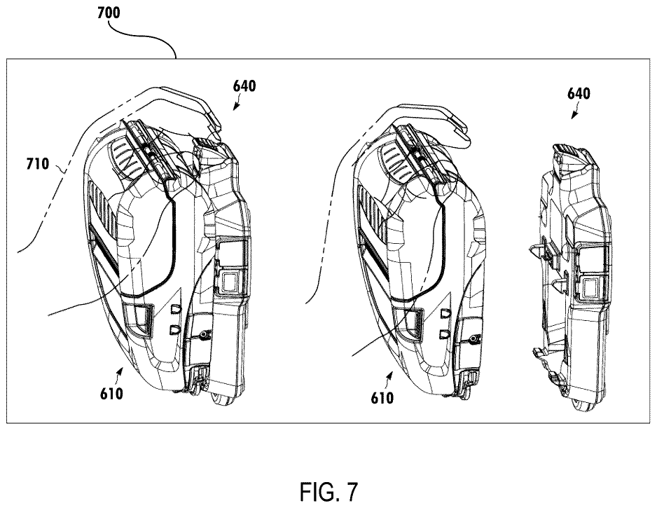

FIG. 7 illustrates a user interfacing with an example system 700 which includes the printing device 610 with the cradle 640, according to embodiments of the present disclosure. Upon engagement of the printing device 610 with the cradle 640, the printing device 610 or the cradle 640 (whichever is responsible for managing charging of the battery 160) may communicate with the computing device 120 or the computing device 210 to acquire a latest set of criteria 144 and/or charging algorithms. The printing device 610 or the cradle 640 may then select a charging algorithm (e.g. the first charging algorithm 180) for the possible set of charging algorithms based on the user specified criteria and begin using the selected charging algorithm to charge the battery 160. Upon disengagement of the printing device 610 from the cradle 640, the printing device 610 or the cradle 640 may pause a currently selected charging algorithm such that subsequent re-engagement of the printing device 610 with the cradle 640 causes the currently selected charging algorithm to resume. The printing device 610 or the cradle 640 may periodically poll the computing device 120 or the computing device 210 to determine whether new criteria 144 and/or a new charging algorithm is available. The computing device 120 or the computing device 210 may alternatively send a notification to the printing device 610 or the cradle 640 when new criteria 144 and/or the new charging algorithm is available. Upon receipt of new criteria 144 and/or the new charging algorithm, the printing device 610 or the cradle 640 may select a new charging algorithm (if new criteria 144 are received; e.g. the second charging algorithm 182) and begin charging the battery 160 with the new charging algorithm in response to the new charging algorithm satisfying the new charging criteria.

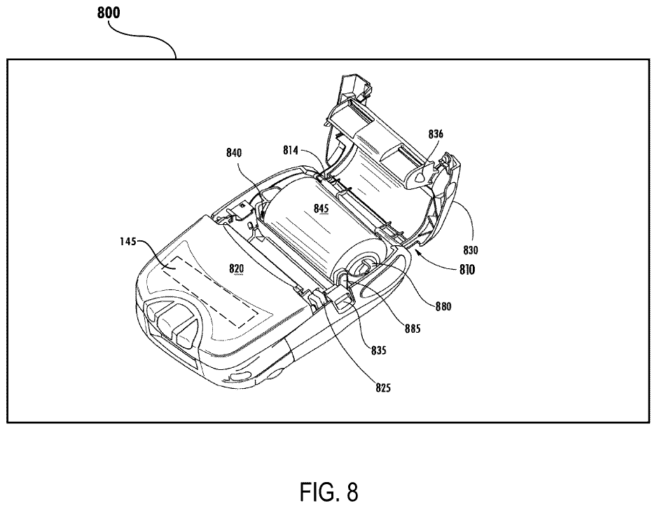

FIG. 8 illustrates an example portable printer 800, according to embodiments of the present disclosure. In the example portable printer a media cover 830 encloses a media receiving area 840, such as a cavity, which stores media 845, such as a web of labels, wristbands, and/or RFID inlays. The media 845 can be inserted into media support arms 880 and locked into place with a locking element 885 when the media cover 830 is closed. The media cover 830 may include a clamshell opening mechanism 810 including a media cover hinge 814. A ribbon cover 820 can be opened by pushing the ribbon cover button 825. The ribbon cover 820 encloses a ribbon receiving area which stores a ribbon cartridge. When the media cover 830 of the printer 800 is closed, a user 140 can depress a media cover button 835 to open the media cover 830. The media cover button 835 may be located in any location that is accessible to the user 140 when the ribbon cover 820 and media cover 830 are closed, such as on a side of the printer 800. The media cover button 835 may engage an internal portion of the media cover 830 in the closed media position such that depressing the button 835 releases the media cover 830 so that it may be opened by a user 140 to expose the media 845 and/or the media receiving area 840, as shown in FIG. 8. For example, depressing the media cover button 835 may release a spring-loaded tab 836 located on a shield housing that is integral to or otherwise attached to the media cover 830. Disengagement of the spring-loaded tab 836 may also serve to urge the media cover 830 away from the rest of the printer housing, towards the opened media position illustrated in FIG. 8.

The printer 800 may include a charging port for connecting a cable to charge an internal battery (e.g., battery 160). Such an embodiment may take the form illustrated in FIG. 1, with the printer 800 being the device 110 and regulating charging of the battery based upon communication with the computing device 120 or computing device 210. The printer 800 may also include a built-in user interface (e.g., the user interface 142) configured to allow a user (e.g., the user 140) to directly provide criteria (e.g., the criteria 144) to the printer 800, eliminating the need for the computing device 120 or the computing device 210 to configure the printer 800 to select the charging algorithms at the cost of complexity of the printer 800 itself. The computing device 120 or computing device 210 may still provide updated or new charging algorithms to the printer 800 which can be configured via the user interface of the printer 800.

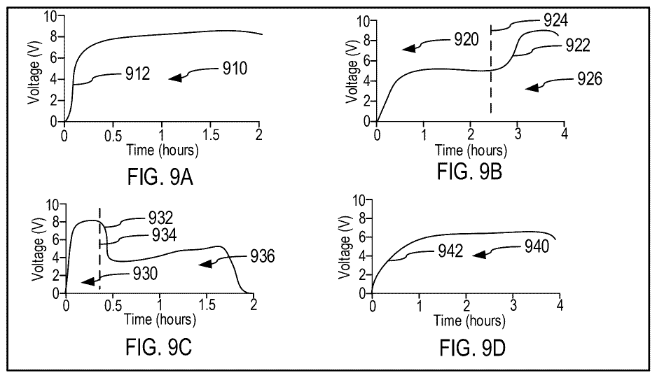

FIG. 9A illustrates a first example charging algorithm 910, according to embodiments of the present disclosure. The first example charging algorithm 910 presents a plot 912 of voltages supplied to a battery 160 when fast charging times are a top priority. In this example plot 912, the charging algorithm 910 supplies the battery 160 with a relatively high voltage very early on in a charging cycle, maintaining or slightly increasing that voltage until the end of the cycle.

FIG. 9B illustrates a second example charging algorithm 920 and a third example charging algorithm 926, according to embodiments of the present disclosure. A plot 922 begins with the second example charging algorithm 920, which is voltage-limited to approximately half of a maximum charging voltage of the battery 160. This may be, for example, because of a desire to consume less electricity during peak demand times paired with a need to complete some charging due to a time availability requirement (all of which is provided by the user 140 in the criteria 144). A dashed vertical line 924 represents a time at which conditions change (e.g. time progresses to an off-peak electricity demand period with lower electricity pricing) such that a third charging algorithm 926 now best satisfies the criteria 144. The voltage across the terminals of the battery 160 is thus raised to a maximum charging voltage for the remainder of the charging cycle.

FIG. 9C illustrates a fourth example charging algorithm 930 and a fifth example charging algorithm 936, according to embodiments of the present disclosure. A plot 932 begins with the fourth example charging algorithm 930, which may not be subject to any voltage limitations (e.g. because the criteria 144 specify the fastest possible charge time). A dashed vertical line 934 represents a time at which conditions change (e.g. the user 140 provides new criteria 144) such that a fifth charging algorithm 936, which is voltage-limited (e.g. because multiple batteries 160 are now charging on a shared circuit) now best satisfies the criteria 144. The voltage across the terminals of the battery 160 is thus lowered to the limit for the remainder of the charging cycle.

FIG. 9D illustrates a sixth example charging algorithm 940, according to embodiments of the present disclosure. The sixth charging algorithm 940 is voltage-limited (e.g. because multiple batteries 160 are being charged on a same circuit) and thus a plot 942 of voltage across terminals of the battery 160 remains at approximately ¾ of the maximum charging voltage for nearly the entire charging cycle.

It will be appreciated that the particular times and voltages depicted in FIGS. 9A-9D are merely illustrative examples, and that actual embodiments may have differing charging times, plot shapes, voltages, and numbers of algorithms involved.

The above description refers to a block diagram of the accompanying drawings. Alternative implementations of the example represented by the block diagram include one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed subject matter is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed:

1. A method, comprising:
configuring a device to charge a battery using two or more charging algorithms;
receiving criteria for the two or more charging algorithms from a user;
selecting a first charging algorithm from the two or more charging algorithms based at least partially on satisfaction of the criteria received from the user; and
charging the battery using the first charging algorithm.

2. The method of claim 1, further comprising:
selecting a second charging algorithm from the two or more charging algorithms; and
switching from the first charging algorithm to the second charging algorithm based on a time specified by the user.

3. The method of claim 2, wherein the time is an elapsed value measured from a start of the charging.

4. The method of claim 2, wherein the time is a time of day.

5. The method of claim 2, further comprising:
measuring the time via a clock that is internal to the device.

6. The method of claim 2, further comprising:
receiving, by the device, a signal which indicates the time from an external clock.

7. The method of claim 1, wherein the configuring is achieved via communication between the device and a server.

8. The method of claim 1, wherein the configuring is achieved via direct communication or local area network (LAN) communication between a host and the device.

9. The method of claim 1, wherein the battery is included in a second device.

10. The method of claim 1, wherein the device is a printer or an indicia decoder.

11. The method of claim 1, wherein the configuring is performed for a plurality of devices simultaneously.

12. A system, comprising:
a battery;
a power supply;
a device; and
a processing device, configured to
configure a device to charge a battery via the power supply using two or more charging algorithms,
receive criteria for the two or more charging algorithms from a user,
select a first charging algorithm from the two or more charging algorithms based at least partially on satisfaction of the criteria received from the user, and
cause the device to charge, via the power supply, the battery using the first charging algorithm.

13. The system of claim 12, wherein the device is a charging device, and the battery is included in a second device which interfaces with the charging device.

14. The system of claim 12, wherein the processing device is further configured to:
select a second charging algorithm from the two or more charging algorithms; and
switch from the first charging algorithm to the second charging algorithm based on a time specified by the user.

15. The system of claim 14, wherein the time is an elapsed value measured from a start of the charging.

16. The system of claim 14, wherein the time is a time of day.

17. The system of claim 12, wherein the processing device is included in a server which interfaces with the device.

18. The system of claim 14, wherein the processing device is included in a host which communicates via a direct connection or a local area network (LAN) with the device.

19. A non-transitory computer-readable medium containing instructions which, when executed by a processing device, cause the processing device to:
configure a device to charge a battery via a power supply using two or more charging algorithms;
receive criteria for the two or more charging algorithms from a user;
select a first charging algorithm from the two or more charging algorithms based at least partially on satisfaction of the criteria received from the user; and
cause the device to charge, via the power supply, the battery using the first charging algorithm.

20. The non-transitory computer-readable medium of claim 19, containing further instructions which, when executed by the processing device, cause the processing device to:
select a second charging algorithm from the two or more charging algorithms; and
switch from the first charging algorithm to the second charging algorithm based on a time specified by the user.
